(19) United States
(12) Patent Application Publication
(10) Pub. No.: US 2015/0199343 A1
(43) Pub. Date: Jul. 16, 2015

(54) OPTIMIZED FILE PROCESSING FOR LINKED CLONE VIRTUAL MACHINES

(71) Applicant: VMWARE, INC., Palo Atio, CA (US)

(72) Inventor: PRASAD DABAK, Pune (IN)

(73) Assignee: VMWARE, INC., Palo Atio, CA (US)

(21) Appl. No.: 14/192,873

(22) Filed: Feb. 28, 2014

(30) Foreign Application Priority Data
Jan. 15, 2014 (IN) 178/CHE/2014

(51) Int. Cl. G06F 17/30; G06F 9/455; G06F 21/62

(52) U.S. Cl. CPC G06F 17/3007; G06F 21/6218; G06F 9/455

(57) ABSTRACT

Techniques for optimizing file processing for linked clone virtual machines (VMs) are provided. In one embodiment, an agent executing within a linked clone VM can determine an identifier for a file to be processed by a file processor, where the identifier is based on a virtual disk location of the file. The agent can then transmit the identifier to the file processor. Upon receiving the identifier, the file processor can detect, using the identifier, whether the file has already been processed. If the file has already been processed, the file processor can short-circuit processing of the file.

### BACKGROUND

As known in the field of computer virtualization, a linked clone virtual machine (referred to herein as a “linked clone VM” or “linked clone”) is a VM that is created from a point-in-time snapshot of another, “parent” VM. Although a linked clone VM is considered a separate virtual machine with its own unique identity, it shares the virtual disks of the parent VM snapshot—in other words, it accesses data directly from the parent virtual disks, as long as that data is not modified by the linked clone VM. This disk sharing property makes linked clone VMs useful in environments where multiple VMs need to access the same software installation, since the VMs can be created as linked clones of a single snapshot (either directly from the snapshot or indirectly in the form of a linked clone chain) and thus share a single set of virtual disks, thereby conserving disk space and simplifying VM provisioning.

When managing a group of linked clone VMs, it is often beneficial to perform various file processing tasks with respect to the VMs on a periodic basis. One such file processing task is anti-virus (AV) scanning. Unfortunately, despite the potential “file overlap” between linked clone VMs due to virtual disk sharing, existing AV scanning implementations generally cannot leverage the scanning results from one linked clone VM to reduce the scanning time for another. For instance, assume three linked clone VMs C1, C2, and C3 share access to a single virtual disk D1. If a prior art AV scanner determines that file F1 on shared virtual disk D1 is “clean” in the context of linked clone VM C1, the AV scanner cannot use this knowledge to short-circuit the scanning of file F1 in the context of linked clone VMs C2 or C3 (even though it is the exact same file in all three contexts). This means that the AV scanner will unnecessarily scan file F1 three times, which wastes system resources and slows down the overall scanning process.

### SUMMARY

Techniques for optimizing file processing for linked clone VMs are provided. In one embodiment, an agent executing within a linked clone VM can determine an identifier for a file to be processed by a file processor, where the identifier is based on a virtual disk location of the file. The agent can then transmit the identifier to the file processor. Upon receiving the identifier, the file processor can detect, using the identifier, whether the file has already been processed. If the file has already been processed, the file processor can short-circuit processing of the file.

The following detailed description and accompanying drawings provide a better understanding of the nature and advantages of particular embodiments.

### BRIEF DESCRIPTION OF THE DRAWINGS

FIG. 1 depicts a virtualized environment comprising linked clone VMs according to an embodiment.

FIG. 2 depicts a process for optimizing file processing within the virtualized environment of FIG. 1 according to an embodiment.

FIGS. 3, 4, and 5 depict exemplary flows using the process of FIG. 2 according to an embodiment.

FIG. 6 depicts a flowchart performed by an agent of a linked clone VM according to an embodiment.

FIG. 7 depicts a flowchart performed by an optimizer component of a file processor according to an embodiment.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof.

The present disclosure describes techniques for optimizing file processing in environments where multiple linked clone VMs share the virtual disks of a common, parent VM snapshot. In one set of embodiments, an agent executing within a linked clone VM can determine an identifier for a file to be processed by a file processor (e.g., an AV scanner, a file backup manager, etc.). The identifier (referred to herein as a “residential address,” or “RA”) can be based on the virtual disk location of the file. Thus, a file that resides on a shared virtual disk will generally resolve to the same RA, regardless of the VM context from which the RA is determined. The agent can then transmit the RA to the file processor.

Upon receiving the RA, an optimizer component of the file processor can determine, based on the RA and a database of RA entries, whether the file has already been processed. For example, in a particular embodiment, the optimizer can check whether the received RA appears in the database. If so, the optimizer can conclude that the file has already been processed and thus can short-circuit (i.e., skip or abort) processing of the file.

On the other hand, if the received RA does not appear in the database, the optimizer can conclude that the file has not yet been processed and thus can cause the file processor to process the file per its normal operation. The optimizer can also insert an RA entry for the file into the database upon completion of the processing. In this way, the optimizer can ensure future file processing requests (from, e.g., other linked clone VMs) that are directed to the same RA will not cause the file processor to unnecessarily re-process the same file.

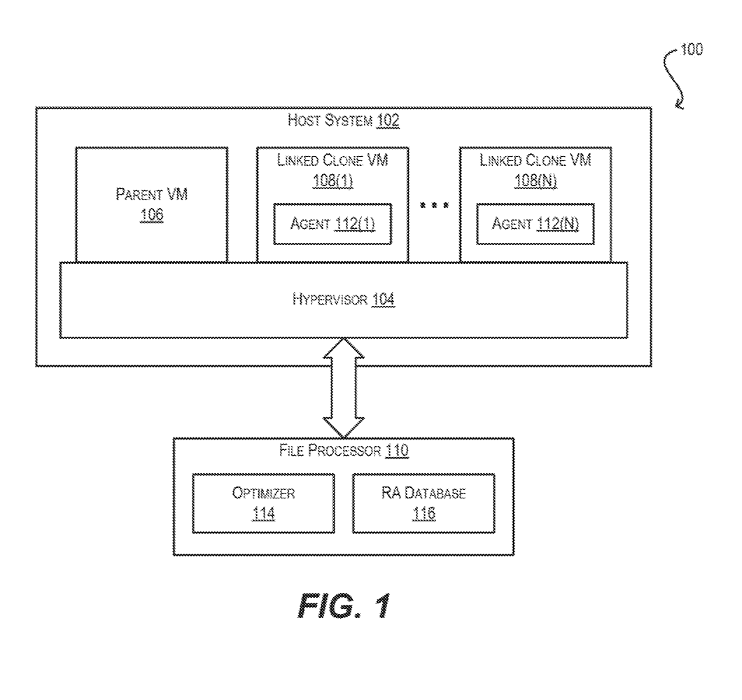

FIG. 1 depicts a virtualized environment 100 that supports optimized file processing for linked clone VMs according to an embodiment. As shown, virtualized environment 100 includes a host system 102 that executes a hypervisor 104 (also known as a “virtualization layer” or “virtualization software”). Hypervisor 104 provides an environment in which one or more VMs can run. In one embodiment, hypervisor 104 can interact directly with the hardware platform of host system 102 without an intervening host operating system. In this embodiment, hypervisor 104 can include a kernel (not shown) that manages VM use of the various hardware devices of host system 102. In an alternative embodiment, hypervisor 104 can be part of a “hosted” configuration in which hypervisor 104 runs on top of a host operating system (not shown). In this embodiment, hypervisor 104 can rely on the host operating system for physical resource management of hardware devices. One of ordinary skill in the art will recognize various modifications and alternatives for the design and configuration of hypervisor 104.

In the example of FIG. 1, hypervisor 104 is configured to execute a parent VM 106 and a number of linked clone VMs 108(1)-(N) that have been created from a snapshot of 106. Generally speaking, a linked clone VM shares the virtual disks of its parent VM snapshot (i.e., the “parent virtual disks”), such that the files used by the linked clone VM are accessed directly from the parent virtual disks. Accordingly, linked clone VMs 108(1)-(N) can be assumed to share a common set of virtual disks from the snapshot of parent VM 106. It should be noted that this virtual disk sharing is broken for a particular file residing on a parent virtual disk when a linked clone VM modifies that file. In this situation, the modified file is written to a delta disk that is specific to the linked clone VM, and the linked clone VM subsequently accesses the modified file from the delta disk (rather than the parent virtual disk) for future reads/writes.

In addition to host system 102, virtualized environment 100 includes a central file processor 110 that is communicatively coupled with hypervisor 104. File processor 110 can be, e.g., an AV scanner, a file backup manager, or any other component that is configured to perform file processing tasks on behalf of the VMs of host system 102. In various embodiments, file processor 110 can receive file processing requests from VMs 106 and 108(1)-(N), execute tasks in accordance with the requests, and then return status/result messages to the originating VMs. For example, in the case where file processor 110 is an AV scanner, file processor 110 can receive a file scan request from a particular VM, scan the file for viruses, and then send a response to the VM indicating whether the scanned file is “clean” or “infected.”

As noted the Background section, one of the limitations of existing AV scanners in VM deployments is that they generally cannot leverage the file overlap between linked clone VMs (resulting from virtual disk sharing) in order to speed up scan times. For instance, in the example of FIG. 1, a prior art AV scanner would not be intelligent enough to recognize that linked clone VMs 108(1)-(N) share a common set of virtual disks from the snapshot of parent VM 106, and thus may inadvertently scan certain files on the parent virtual disks multiple times (once per linked clone VM).

To address these and other similar limitations, virtualized environment 100 includes an agent 112(1)-(N) within each linked clone VM 108(1)-(N), as well as an optimizer component 114 and RA database 116 within file processor 110. Although not shown, agent 112 may also reside in parent VM 106 (and thus may be automatically propagated to linked clone VMs 108(1)-108(N) at the time of provisioning). As described in further detail below, agents 112(1)-112(N) can interoperate with optimizer 114 and RA database 116 in a manner that allows file processor 110 to detect, at the time of receiving a file processing request from a linked clone VM 108(1)-(N), whether the file has already been processed. For example, if the file resides on a shared virtual disk, components 112(1)-(N), 114, and 116 can enable file processor 110 to detect whether it has already processed the file in response to, e.g., a request from another linked clone VM. File processor 110 can then skip or otherwise terminate processing of the file if it has been processed. In this way, components 112(1)-(N), 114, and 116 can eliminate the inefficiencies associated with prior art AV scanning solutions and, more generally, can be used to speed up/optimize any type of cross-VM file processing task (e.g., AV scanning, file backup, file indexing, etc.).

It should be appreciated that virtualized environment 100 is illustrative and not intended to limit the embodiments herein. For instance, although file processor 110 is shown as being separate from host system 102, in certain embodiments file processor 110 can be implemented within an “appliance VM” that runs on top of hypervisor 104. In these embodiments, the appliance VM can be a virtual machine that is dedicated to performing the functions of file processor 110. Alternatively, file processor 110 can be implemented within a VM running on a different host system, or on a physical machine. Further, the various entities depicted in virtualized environment 100 may have other capabilities or include other subcomponents that are not specifically described. One of ordinary skill in the art will recognize many variations, modifications, and alternatives.

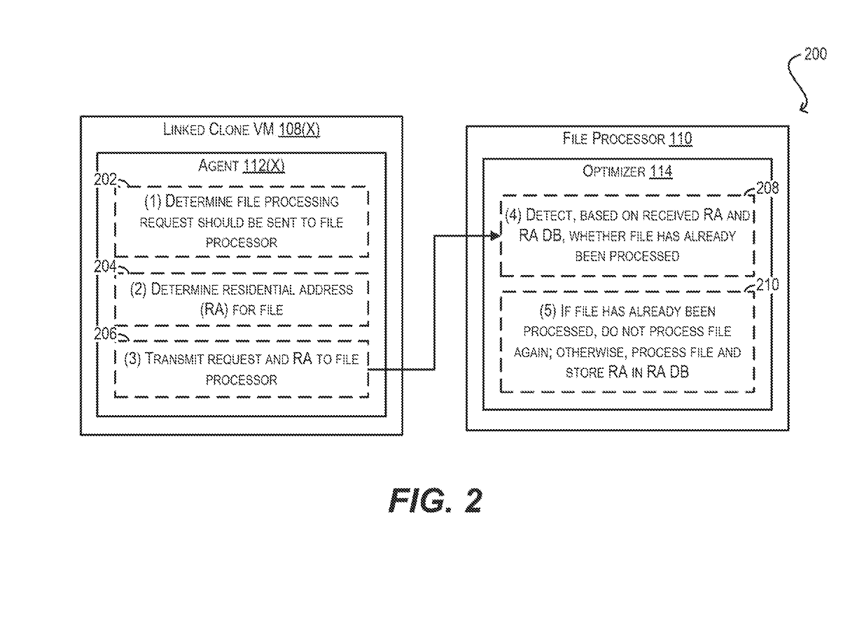

FIG. 2 depicts a high-level process 200 that can be carried out by an agent 112(X) of a particular linked clone VM 108(X) and by optimizer 114 of file processor 110 in order to optimize file processing according to an embodiment. At step (1) (reference numeral 202), agent 112(X) can determine that a file processing request for a file should be sent to file processor 110. For example, agent 112(X) can make this determination in response to a command received from file processor 110 (e.g. an on-demand scan), or in response to a rule or event within linked clone VM 108(X) (e.g., a file access event).

At step (2) (reference numeral 204), agent 112(X) can determine a residential address, or RA, for the file. As noted previously, the RA can be based on the virtual disk location of the file (rather than its guest OS disk location). Thus, generally speaking, the RA for the file will be the same across multiple linked clone VMs in situations where the file is shared via virtual disk sharing (since the file resides in the same parent virtual disk location, regardless of VM context). The RA for the file will only differ for a particular linked clone VM if the file has been modified, because in that scenario the RA will reflect a location on the VM's local delta disk, rather than the shared parent virtual disk.

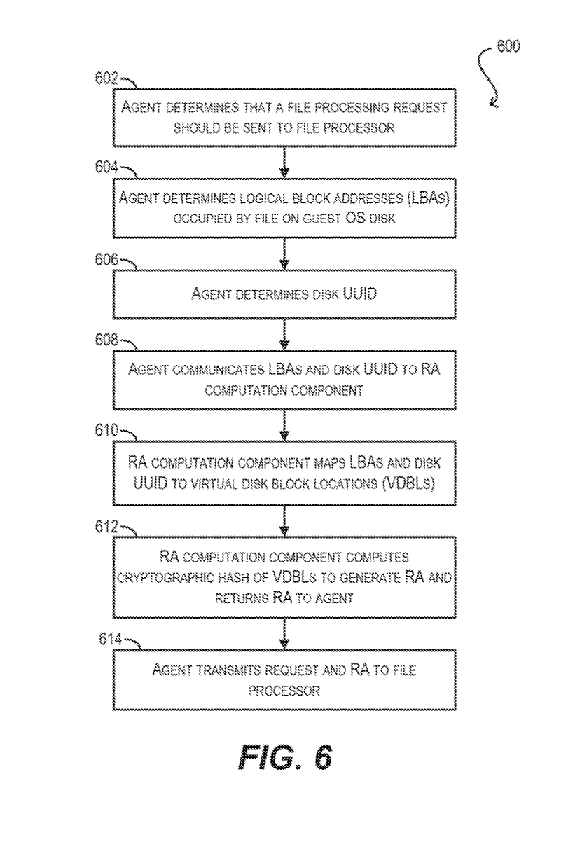

In one embodiment, as part of the RA determination at step (2), agent 112(X) can interact with an RA computation component that resides within hypervisor 104 (not shown). As described with respect to FIG. 6 below, the RA computation component can be configured to compute the RA on behalf of agent 112(X) (based on, e.g., the logical block addresses of the file on the guest OS disk and the guest OS disk identifier).

Once the RA has been determined, agent 112(X) can transmit the file processing request and the RA to file processor 110 (step (3); reference numeral 206). Optimizer 114 of file processor 110 can then detect, using the received RA and RA database 116, whether the file has already been processed (step (4); reference numeral 208). In certain embodiments, RA database 116 can be configured to maintain the RAs (as well as other information, such as filenames and statuses) of all previously processed files. Accordingly, step (4) can comprise checking whether the received RA is found in RA database 116. It should be noted that RA database 116 can be implemented using any type of data structure, such as a hash map, key-value store, flat file, etc., and therefore is not limited to a traditional, relational database.

If optimizer 114 determines that the file has already been processed (e.g., the RA for the file is found in RA database 116), optimizer 114 can cause file processor 110 to short-circuit the processing of the file (step (5); reference numeral 210). This may occur if, e.g., the file was previously processed in the context of a different linked clone VM that shares the same parent virtual disk. In this manner, optimizer 114 can prevent file processor 110 from unnecessarily re-processing the same shared file.

On the other hand, if optimizer 114 determines that the file has not yet been processed (e.g., the RA for the file is not found in RA database 116), optimizer 114 can cause file processor 110 to process the file per its normal operation (step (5); reference numeral 210). For example, if file processor 110 is an AV scanner, optimizer 114 can cause file processor 110 to scan the file for viruses. As another example, if file processor 110 is a backup manager, optimizer 114 can cause file processor 110 to back up the file to secondary storage. Optimizer 114 can then save the RA in RA database 116 (as well as, e.g., the status/results of the processing) so that the processing of the file can be short-circuited in the future.

Although not shown in FIG. 2, in situations where the processing performed by file processor 110 is unsuccessful (or returns an undesirable result, such as “infected”), optimizer 114 may choose to skip the step of saving the RA in RA database 116 and instead generate an error or log message. This will cause file processor 110 to try and re-process the file the next time a request with the same RA is received. File processor 110 may also remediate the file (by, e.g., attempting to remove a virus infection). In this case, the RA of the file would be changed due to the remediation process and, upon subsequent accesses/requests, the new RA would be used.

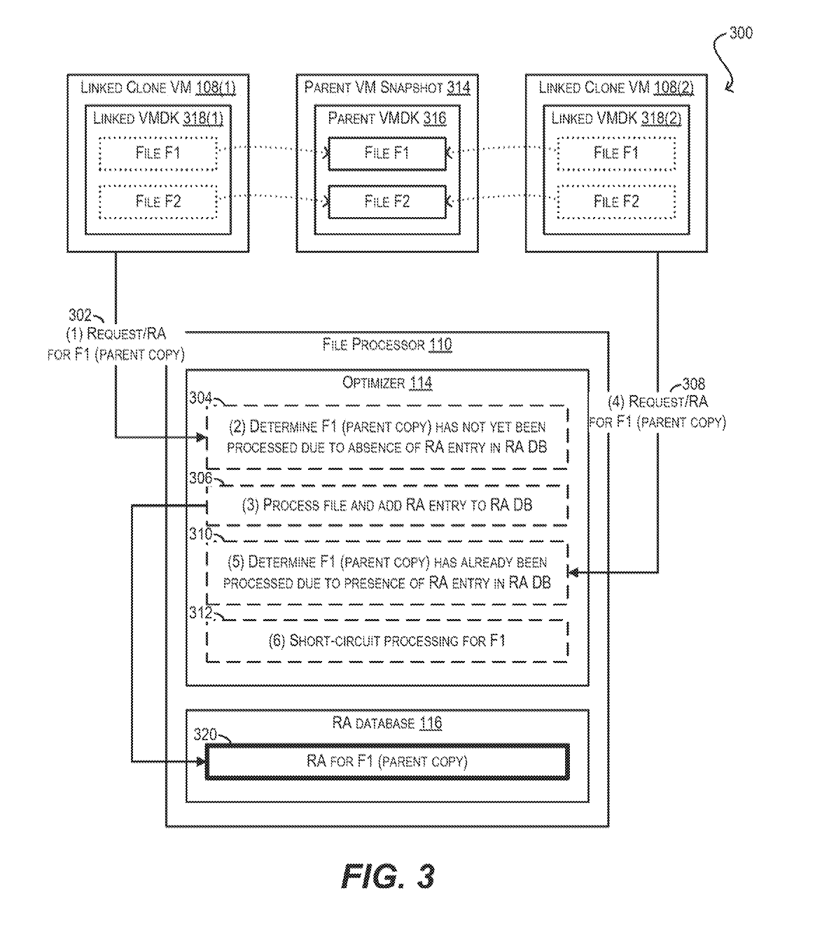

To further clarify the operation of agents 112(1)-(N) and optimizer 114, FIGS. 3, 4 and 5 depict exemplary flows 300, 400, and 500 respectively that illustrate the application of process 200 in various scenarios. In these scenarios, it is assumed that two linked clone VMs 108(1) and 108(2) have been created (either directly or indirectly in the form of a linked clone chain) from a snapshot 314 of parent VM 106, and thus share a parent virtual disk (VMDK) 316 of snapshot 314 (comprising files F1 and F2). This is shown by the dotted arrows from linked VMDK 318(1) of linked clone VM 108(1) and linked VMDK 318(2) of linked clone VM 108(2) to parent VMDK 316.

Starting with flow 300 of FIG. 3, at step (1) (reference numeral 302), the agent of linked clone VM 108(1) can transmit a file processing request and RA for file F1 to file processor 110. Note that since linked clone VM 108(1) is currently sharing the copy of file F1 from snapshot 314, the RA transmitted at step (1) identifies the parent copy of the file located in parent VMDK 316.

At step (2) (reference numeral 304), optimizer 114 of file processor 110 can determine that file F1 (parent copy) has not yet been processed because the received RA is not found in RA database 116. As a result, optimizer 114 can cause file processor 110 to process the file and can add an RA entry 320 for file F1 (parent copy) to RA database 116 (step (3); reference numeral 306).

At some later point in time, the agent of linked clone VM 108(2) can transmit a file processing request and RA for the same file F1 to file processor 110 (step (4); reference numeral 308). Like linked clone VM 108(1), linked clone VM 108(2) is currently sharing the copy of file F1 from snapshot 314. Accordingly, the RA transmitted at step (4) identifies the parent copy of the file located in parent VMDK 316.

At step (5) (reference numeral 310), optimizer 114 can determine that file F1 (parent copy) has already been processed since its RA exists (in the form of entry 320) in RA database 116. Thus, optimizer 114 can short-circuit the processing of file F1 in response to VM 108(2)'s request (step (6); reference numeral 312).

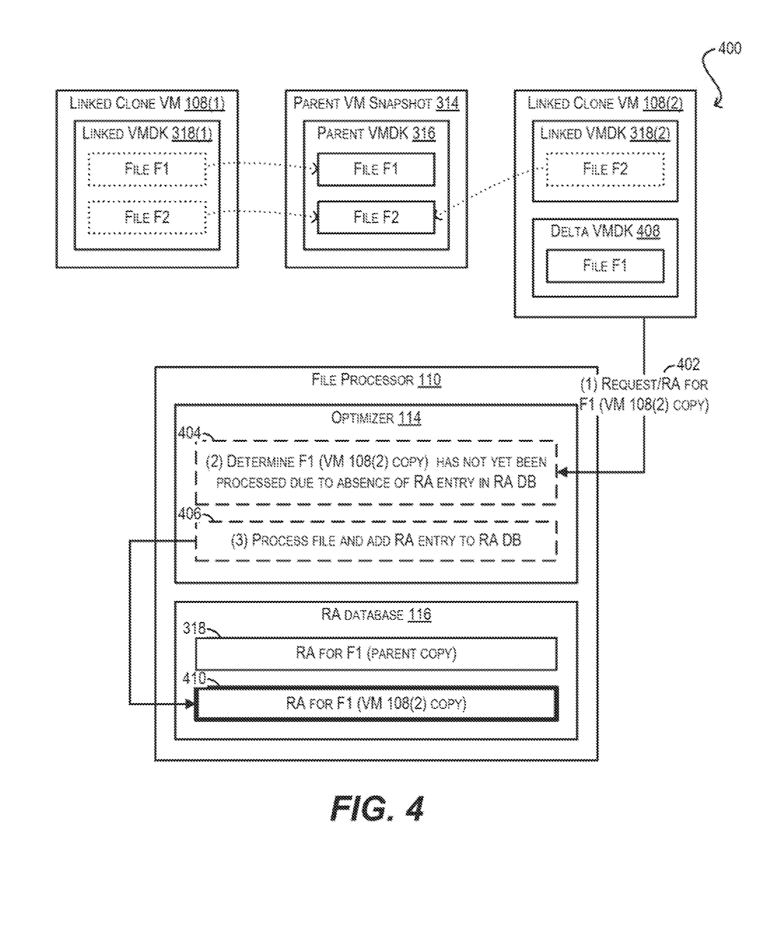

Turning now to FIG. 4, flow 400 illustrates a scenario (after flow 300) where linked clone VM 108(2) has modified file F1. As a result, a local copy of file F1 has been created in a delta VMDK 408 of linked clone VM 108(2), and the link for file F1 between linked VMDK 318(2) and parent VMDK 316 has been broken/deleted.

At step (1) of flow 400 (reference numeral 402), the agent of linked clone VM 108(2) can transmit a file processing request and RA for file F1 to file processor 110. Since file F1 has been modified, linked clone VM 108(2) is no longer sharing the parent copy of the file. Accordingly, the RA transmitted at step (1) identifies the copy of F1 in delta VMDK 408 (referred to as the “VM 108(2) copy”).

At step (2) (reference numeral 404), optimizer 114 can determine that that file F1 (VM 108(2) copy) has not yet been processed because the received RA is not found in RA database 116. Note that the received RA does not match existing RA entry 320, because RA entry 320 identifies the parent copy of F1. In response, optimizer 114 can cause file processor 110 to process file F1 (VM 108(2) copy) and can add a new RA entry 410 for the file to RA database 116 (step (3); refirence numeral 406).

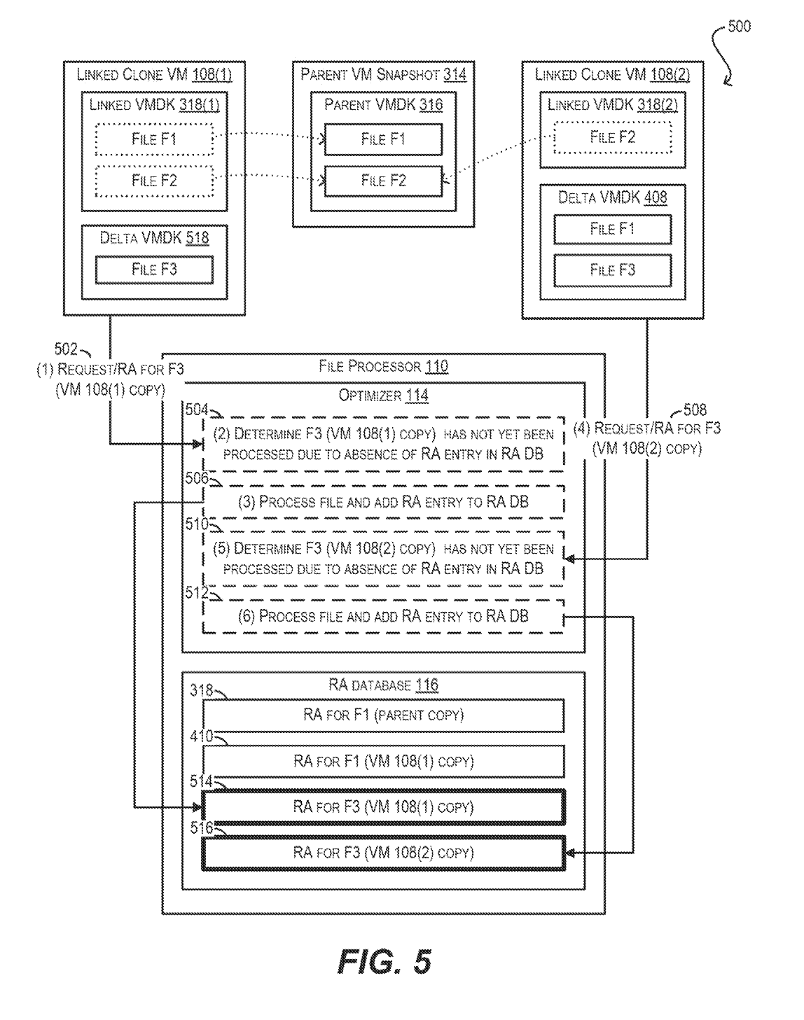

Finally, turning to FIG. 5, flow 500 illustrates a scenario (after flow 400) where linked clone VMs 108(1) and 108(2) have each independently created a new file F3. In this scenario, the copy of file F3 created by linked clone VM 108(1) is maintained in delta VMDK 518, and the copy of file F3 created by linked clone VM 108(2) is maintained in delta VMDK 408.

At step (1) of flow 500 (reference numeral 502), the agent of linked clone VM 108(1) can transmit a file processing request and RA for file F3 to file processor 110. The RA transmitted at step (1) identifies the copy of F3 in delta VMDK 518 (referred to as the “VM 108(1) copy”).

At step (2) (reference numeral 504), optimizer 114 can determine that file F3 (VM 108(1) copy) has not yet been processed because the received RA is not found in RA database 116. In response, optimizer 114 can cause file processor 110 to process file F3 (VM 108(1) copy) and can add an RA entry 514 for the file to RA database 116 (step (3); reference numeral 506).

At some later point in time, the agent of linked clone VM 108(2) can transmit a file processing request and RA for its own file F3 to file processor 110 (step (4); reference numeral 508). The RA transmitted at step (4) identifies the copy of F3 in delta VMDK 408 (referred to as the “VM 108(2) copy”), which is different from the RA transmitted by the agent of linked clone VM 108(1) at step (1).

At step (5) (reference numeral 510), optimizer 114 can determine that file F3 (VM 108(2) copy) has not yet been processed because the received RA is not found in RA database 116. In response, optimizer 114 can cause file processor 110 to process file F3 (VM 108(2) copy) and can add an RA entry 516 for the file to RA database 116 (step (6); reference numeral 512).

The remaining portions of this disclosure provide additional implementation details regarding the processing attributed to agents 112(1)-(N) and optimizer 114 in FIGS. 2-5. For instance, FIG. 6 depicts a detailed flowchart 600 of the steps that may be performed by a particular agent 112(X) at the time of transmitting a file processing request to file processor 110 according to an embodiment.

At block 602, agent 112(X) can determine that a file processing request for a file should be sent to file processor 110. As discussed with respect to step (1) of FIG. 2, agent 112(X) can make this determination in response to, e.g., a command received from file processor 110 (e.g., an on-demand scan), or a rule/event within linked clone VM 108(X), such as a file access event.

At blocks 604 and 606, agent 112(X) can determine the logical block addresses (LBAs) occupied by the file on the VM's guest OS disk, as well as the UUID of the guest OS disk. Agent 112(X) can then communicate the LBAs and the disk UUID to an RA computation component within hypervisor 104 (block 608).

At block 610, the RA computation component can map the received LBAs and disk UUID to the virtual disk block locations (VDBLs) of the file. For instance, if the file is located on a shared virtual disk, the RA computation component can determine the VDBLs occupied by the file on the shared virtual disk.

Once the VDBLs have been mapped, the RA computation component can compute a cryptographic hash of the VDBLs to generate the RA for the file (block 612). Examples of hash functions that may be used at this step include SHA-1, SHA-2, MD5, and the like. The RA computation component can subsequently return the generated RA to agent 112(X).

Finally, at block 614, agent 112(X) can transmit the RA and the file processing request (which may include, e.g., the filename, the file content, and other information) to file processor 110.

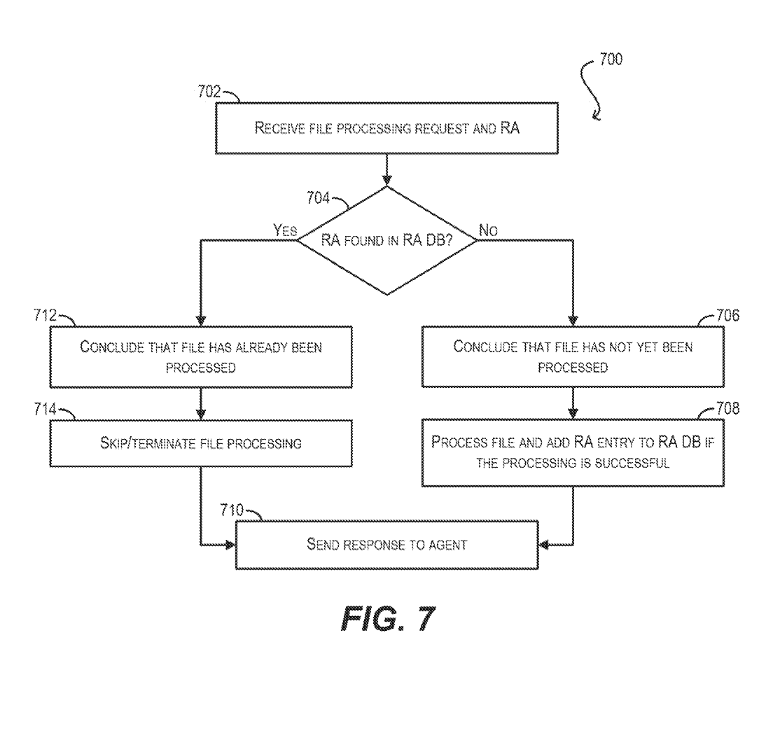

FIG. 7 depicts a detailed flowchart 700 of the steps that may be performed by optimizer 114 of file processor 110 upon receiving the RA and file processing request transmitted by agent 112(X) at block 614 of FIG. 6 according to an embodiment.

At blocks 702 and 704, optimizer 114 can receive the file processing request/RA and can check whether the RA is found in RA database 116. If the RA is not found, optimizer 114 can conclude that the file has not yet been processed (block 706). Thus, optimizer 114 can cause file processor 110 to process the file and can add an entry for the RA to RA database 116 (if the processing is successful) (block 708). In certain embodiments, as part of block 708, optimizer 114 can include the processing status/results in the newly added RA entry (e.g., “clean” or “infected” in the case of AV scanning). Optimizer 114 can then return the status/results to agent 112(X) (block 710) and flowchart 700 can end.

If the RA is found in RA database 116, optimizer 114 can conclude that the file has already been processed (block 712). In this case, optimizer 714 can skip or terminate the processing of the file and return an appropriate response to agent 112(X) (blocks 714 and 710). If RA database 116 includes a processing status/result in the detected RA entry, optimizer 114 can include the status/result in the response.

The embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a general purpose computer system selectively activated or configured by program code stored in the computer system. In particular, various general purpose machines may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any data storage device that can store data which can thereafter be input to a computer system. The non-transitory computer readable media may be based on any existing or subsequently developed technology for embodying computer programs in a manner that enables them to be read by a computer system. Examples of non-transitory computer readable media include a hard drive, network attached storage (NAS), read-only memory, random-access memory (e.g., a flash memory device), a CD (Compact Disc) (e.g., CD-ROM. CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

In addition, while described virtualization methods have generally assumed that virtual machines present interfaces consistent with a particular hardware system, persons of ordinary skill in the art will recognize that the methods described can be used in conjunction with virtualizations that do not correspond directly to any particular hardware system. Virtualization systems in accordance with the various embodiments, implemented as hosted embodiments, non-hosted embodiments or as embodiments that tend to blur distinctions between the two, are all envisioned. Furthermore, certain virtualization operations can be wholly or partially implemented in hardware.

Many variations, modifications, additions, and improvements are possible, regardless the degree of virtualization. The virtualization software can therefore include components of a host, console, or guest operating system that performs virtualization functions. Plural instances can be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments, and are presented to illustrate the flexibility and advantages of particular embodiments as defined by the following claims. Other arrangements, embodiments, implementations and equivalents can be employed without departing from the scope hereof as defined by the claims.

We claim:

1. A method for optimizing file processing for linked clone virtual machines (VMs), the method comprising:
determining, by an agent executing within a linked clone VM, an identifier for a file to be processed by a file processor, the identifier being based on a virtual disk location of the file;
transmitting, by the agent, the identifier to the file processor;
detecting, by the file processor using the identifier, whether the file has already been processed; and
if the file has already been processed, short-circuiting processing of the file.

2. The method of claim 1 wherein the detecting comprises:
determining whether the identifier exists in a database of processed files;
if the identifier exists in the database, concluding that the file has already been processed; and
if the identifier does not exist in the database, concluding that the file has not yet been processed.

3. The method of claim 2 wherein if the file has not yet been processed, the method further comprises, by the file processor:
processing the file; and
adding the identifier to the database.

4. The method of claim 1 wherein determining the identifier for the file comprises:
determining one or more logical block addresses (LBAs) occupied by the file on a guest OS disk of the linked clone VM;
determining an identifier of the guest OS disk;
mapping the one or more LBAs and the identifier of the guest OS disk to one or more virtual disk block locations (VDBLs) of a virtual disk; and
calculating the identifier for the file by applying a cryptographic hash function to the one or more VDBLs.

5. The method of claim 4 wherein the virtual disk is a parent virtual disk that is shared by a plurality of linked clone VMs.

6. The method of claim 1 wherein the file processor is an anti-virus scanner.

7. The method of claim 1 wherein the file processor is configured to run within an appliance VM that is separate from the linked clone VM.

8. A non-transitory computer readable storage medium having stored thereon software executable by a host system, the software embodying a method that comprises:
determining, by an agent executing within a linked clone VM of the host system, an identifier for a file to be processed by a file processor, the identifier being based on a virtual disk location of the file;
transmitting, by the agent, the file access event and the identifier to the file processor;
detecting, by the file processor using the identifier, whether the file has already been processed; and
if the file has already been processed, short-circuiting processing of the file.

9. The non-transitory computer readable storage medium of claim 8 wherein the detecting comprises:
determining whether the identifier exists in a database of processed files;
if the identifier exists in the database, concluding that the file has already been processed; and
if the identifier does not exist in the database, concluding that the file has not yet been processed.

10. The non-transitory computer readable storage medium of claim 9 wherein if the file has not yet been processed, the method further comprises, by the file processor:
processing the file; and
adding the identifier to the database.

11. The non-transitory computer readable storage medium of claim 8 wherein determining the identifier for the file comprises:
determining one or more logical block addresses (LBAs) occupied by the file on a guest OS disk of the linked clone VM;
determining an identifier of the guest OS disk;
mapping the one or more LBAs and the identifier of the guest OS disk to one or more virtual disk block locations (VDBLs) of a virtual disk; and
calculating the identifier for the file by applying a cryptographic hash function to the one or more VDBLs.

12. The non-transitory computer readable storage medium of claim 11 wherein the virtual disk is a parent virtual disk that is shared by a plurality of linked clone VMs.

13. The non-transitory computer readable storage medium of claim 8 wherein the file processor is an anti-virus scanner.

14. The non-transitory computer readable storage medium of claim 8 wherein the file processor is configured to run within an appliance VM that is separate from the linked clone VM.

15. A computer system comprising:
a processor; and
a non-transitory computer readable medium having stored thereon program code that causes the processor to, upon being executed:
determine an identifier for a file to be processed in the context of a linked clone VM, the identifier being based on a virtual disk location of the file;
detect, using the identifier, whether the file has already been processed; and
if the file has already been processed, short-circuit processing of the file.

16. The computer system of claim 15 wherein the detecting comprises:
determining whether the identifier exists in a database of processed files;
if the identifier exists in the database, concluding that the file has already been processed; and
if the identifier does not exist in the database, concluding that the file has not yet been processed.

17. The computer system of claim 16 wherein, if the file has not yet been processed, the processor is further configured to:
process the file; and
add the identifier to the database.

18. The computer system of claim 15 wherein determining the identifier for the file comprises:
determining one or more logical block addresses (LBAs) occupied by the file on a guest OS disk of the linked clone VM;
determining an identifier of the guest OS disk;
mapping the one or more LBAs and the identifier of the guest OS disk to one or more virtual disk block locations (VDBLs) of a virtual disk; and
calculating the identifier for the file by applying a cryptographic hash function to the one or more VDBLs.

19. The computer system of claim 18 wherein the virtual disk is a parent virtual disk that is shared by a plurality of linked clone VMs.

20. The computer system of claim 15 wherein the processing to be performed on the file is anti-virus scanning.

21. The computer system of claim 15 wherein the processing to be performed on the file is configured to run within an appliance VM that is separate from the linked clone VM.
